(19) United States
(12) Patent Application Publication
(10) Pub. No.: US 2013/0139196 A1
(43) Pub. Date: May 30, 2013

(54) AUTOMATED AUTHORIZATION FOR VIDEO ON DEMAND SERVICE

(71) Applicants: Igor Sokolov, Tver (RU); Vsevolod Kuznetsov, Sankt-Petersburg (RU); Sergey Stepanov, Sankt-Petersburg (RU)

(72) Inventors: Igor Sokolov, Tver (RU); Vsevolod Kuznetsov, Sankt-Petersburg (RU); Sergey Stepanov, Sankt-Petersburg (RU)

(73) Assignee: RAWLLIN INTERNATIONAL INC., Tortola (VI)

(21) Appl. No.: 13/308,387

(22) Filed: Nov. 30, 2011

(51) Int. Cl. H04N 21/25

(52) U.S. Cl. 725/25

(57) ABSTRACT

Providing for automated network-related user authentication in conjunction with video on demand streaming media services is described herein. A network-enabled media playback device, such as a television, can be configured to initiate a network process in response to being powered-on. The network process can facilitate access to a network data store, where stored data indicative of authorization status of one or more user accounts can be obtained, and used for loading account preferences associated with a user. Where no accounts are authorized, a login and authorization message is sent to a communication account associated with the network-enabled playback device to facilitate authenticating and logging a user into the network-enabled playback device. Particular aspects provide for filtering media content based on user preferences and account profile information, and displaying a subset of preferred content, or automatically initiating playback of a selected media program for the user account.

### TECHNICAL FIELD

The subject disclosure relates generally to video on demand media services, and more particularly to providing automated authorization for video on demand television services.

### BACKGROUND

With the advent of the Internet and widespread consumer access to network data content, conventional media has expanded to Internet media services. For instance, television content providers traditionally offering television services over television airwaves or direct cable line, etc., have begun storing television media on network data stores and offering the television media for consumption over the Internet in the form of streaming media. Likewise, radio providers have begun storing audio content on network data stores, and offering streaming media audio services to subscribers, or the general Internet public. Computers configured to communicate on the Internet and playback media content can generally be employed to access, acquire and consume various networked media content. As networked computer users have become more ubiquitous throughout the world, a rapidly growing demand has arisen for more traditional media content to be made available over the Internet.

To satisfy some of this demand, the type and variety of electronic devices configured to communicate and access content on the Internet has begun to expand. For instance, radios and television sets—devices long accustomed by the consuming public for use in acquiring and playing media content—have been configured as computing devices capable of accessing a network, employing various network communication protocols, and downloading and playing media content stored on the network. For instance, Internet-ready television sets have appeared on the market, providing access to websites that provide streaming media content. This has provided a paradigm-shift in viewing television content. Whereas consumers traditionally were required to tune to a particular television station (e.g., a cable station, a broadcast station, a satellite television station, etc.) and receive content broadcast or otherwise transmitted by respective stations at a given time, consumers are now available to access and play any content stored on a networked data store and made available through a website or other server mechanism. In other words, in replacing the broadcast television transmitter with a multiple access computer server, respective playback devices can form respective communication channels with the computer server, each independently receiving selected content.

To facilitate provision of Internet media content, content providers establish user accounts and authenticate users or playback devices on the user accounts as a condition to providing the content. A common case is to require login and authentication for user accounts, before media content is delivered. This can be tedious, however, and diminish user experience of online media content. In addition, online media functionality can often become cumbersome when accessed through traditional television interfaces. Upcoming technological advances aim to improve user experience of online media content and ease-of-use for networked-enabled media playback devices.

### SUMMARY

The following description and the annexed drawings set forth in detail certain illustrative aspects of the disclosed subject matter. These aspects are indicative, however, of but a few of the various ways in which the principles of the various embodiments may be employed. The disclosed subject matter is intended to include all such aspects and their equivalents. Other advantages and distinctive features of the disclosed subject matter will become apparent from the following detailed description of the various embodiments when considered in conjunction with the drawings.

In various aspects of the subject disclosure, automated user authentication is provided in conjunction with video on demand streaming media services. A network-enabled media playback device, such as a television, can be configured to initiate a network process in response to being powered-on. The network process can initiate communication over a network communicatively connected to the network-enabled playback device, and access a network data store. Stored data indicative of whether a user account is currently authenticated can be extracted from the network data store, and used to load user profile data, and to configure media content for playback according to the user profile data. If no user account is currently authenticated, a login and authorization message is sent to a communication account associated with the network-enabled playback device to facilitate authenticating and logging a user into the network-enabled playback device.

According to particular aspects of the subject disclosure, a login and authorization message can be displayed on the network-enabled television set, or sent via an electronic messaging network (e.g., e-mail, short message service, text message, multimedia messaging service, Internet messaging service, website messaging service, social media messaging service, and so forth) to a communication or messaging account stored on the network data store. The login and authorization message can include personal identification data suitable for authorizing the identity of a user of the user account. The personal identification data can then be entered onto the network-enabled playback device, and utilized for authenticating and logging a user into a user account. In at least one aspect of the subject disclosure, the personal identification data can be configured particularly for a user input device of the network-enabled playback device (e.g., a series of button-presses particular to a television remote control). This can facilitate quick and non-cumbersome entry of data for logging into the network-enabled playback device.

According to one or more other aspects, the network-enabled playback device can be configured to auto play content upon successful authorization and login to a user account. User usage profile information can be utilized to filter available media content, and identify a subset of the media content for a user of the user account. A media program of the subset of media content can be selected for automatic playback upon logging into or powering-on the network-enabled playback device. In alternative aspects, selection of the media program can be random, patterned, or predictive based on usage history of the user, user preferences, and so on. In conjunction with automatic playback of the media program, a subset of a display screen can present graphical icons depicting other media programs of the media content, providing quick access to a subset of content preferred by the user. In one aspect, playback, content or navigation controls can be loaded in conjunction with login to the user account, which can regulate access to media content, amount of content for playback, time for playback, control of output device, or the like.

The following description and the annexed drawings set forth in detail certain illustrative aspects of the disclosed subject matter. These aspects are indicative, however, of but a few of the various ways in which the principles of the innovation can be employed and the disclosed subject matter is intended to include all such aspects and their equivalents. Other advantages and novel features of the disclosed subject matter will become apparent from the following detailed description of the innovation when considered in conjunction with the drawings.

### BRIEF DESCRIPTION OF THE DRAWINGS

FIG. 1 illustrates a block diagram of an example system configured to provide automated network-related user authentication for network-enabled media.

FIG. 2 depicts a block diagram of an example network-enabled television according to one or more aspects of the subject disclosure.

FIG. 3 illustrates a block diagram of an example system configured to facilitate remote login in response to powering-on a network-enabled playback device.

FIG. 4 depicts a block diagram of an example system configured to provide content filtering and automated playback for network-enabled media.

FIG. 5 illustrates a block diagram of an example graphical display and interface for a network-enabled television according to particular aspects.

FIG. 6 depicts a flowchart of a sample method for providing network-related user authentication for network media playback, according to further aspects.

FIGS. 7 and 8 illustrate a flowchart of an example method for providing advanced user authentication and content filtering for network-enabled media content.

FIG. 9 depicts a block diagram of a sample electronic computing device that can be implemented in conjunction with one or more disclosed aspects.

FIG. 10 illustrates a block diagram of a sample data communication network that can be operable in conjunction with various aspects described herein.

FIG. 11 depicts a block diagram of an example mobile communication network that can be operable to facilitate network-related user account login.

### DETAILED DESCRIPTION

The disclosed subject matter is described with reference to the drawings, wherein like reference numerals are used to refer to like elements throughout the description. In the following description, for purposes of explanation, numerous specific details are set forth in order to provide a thorough understanding of the subject innovation. It may be evident, however, that the disclosed subject matter may be practiced without these specific details. In other instances, well-known structures and devices are shown in block diagram or schematic form in order to facilitate describing the subject innovation.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “module”, “interface,” “user interface”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The word “exemplary” where used herein means serving as an example, instance, or illustration. For the avoidance of doubt, the subject matter disclosed herein is not limited by such examples. In addition, any aspect or design described herein as “exemplary,” “demonstrative,” or the like, is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

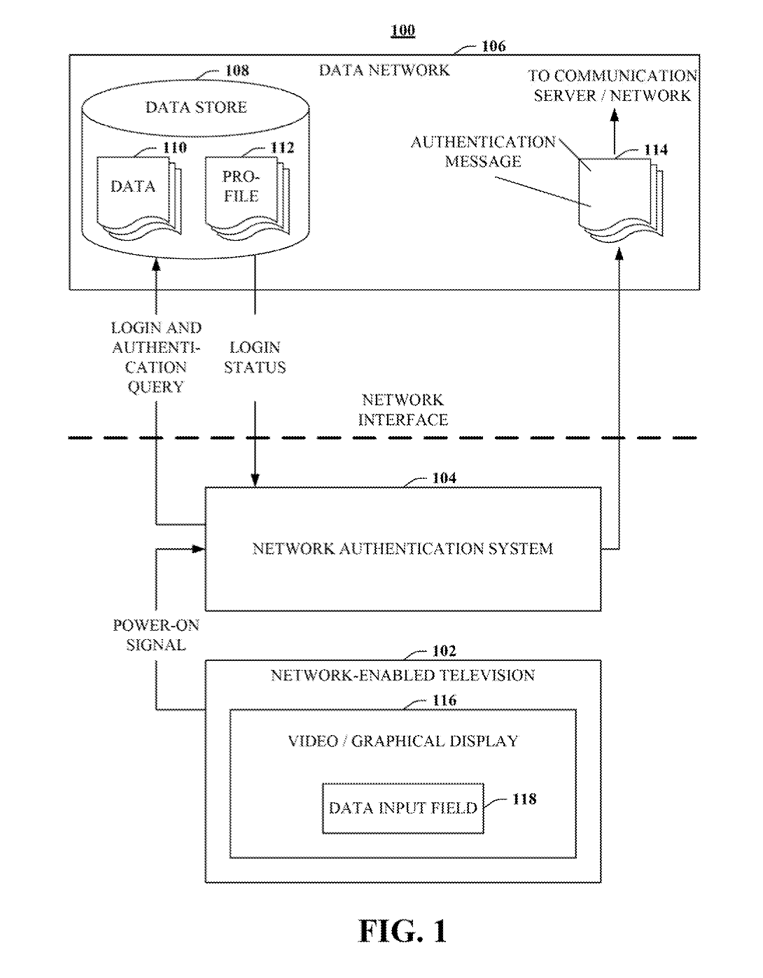

Referring now to the drawings, FIG. 1 illustrates a block diagram of an example system 100 configured to provide network-related account authentication for network-enabled media services, according to one or more aspects of the subject disclosure. System 100 can comprise a network-enabled television 102 communicatively connected with a network authentication system 104. Network authentication system 104 can be packaged within network-enabled television 102, or can be a separate system physically connected with network-enabled television 102 through a wired or wireless communication interface. In at least one aspect (not depicted), network authentication system 104 can be located within a data network through which network-enabled television 102 is configured to electronically communicate.

Network-enabled television 102 can comprise any suitable video playback device having an interface to a conventional broadcast video and audio signal (e.g., licensed television frequency, cable television hookup, optical fiber television hookup, satellite television hookup, or the like, or a suitable combination thereof) and an interface to a data network 106. Data network 106 can be, for instance, an Internet Protocol (IP) based network, such as the Internet, a local network, a wide area network, an intranet, or the like. It should be appreciated that data network 106 can be a network that employs other communication or data transfer protocols, or that uses IP in conjunction with one or more other protocols, in one or more aspects of the subject disclosure.

Upon being powered-on (e.g., by remote control, by button-press on network-enabled television, . . . ), a power-on signal is sent to network authentication system 104. In response to receiving the power-on signal, network authentication system 104 can be configured to automatically initiate a communication session (e.g., an IP session) on data network 106. A login and authentication query can be sent to a network data store 108, which maintains a data file 110 comprising information pertaining to one or more user accounts associated with network-enabled television 102, or a content provider associated with network-enabled television 102. In addition, data file 110 can store information indicative of whether one or more of the user accounts is activated, currently logged on, authenticated, or the like.

User accounts stored in data file 110 can be subscriber accounts maintained by a television service provider, in one aspect of the subject disclosure (e.g., cable television provider, satellite television provider, Internet television provider, . . . ). In at least one aspect, however, data file 110 can comprise user accounts related to additional communication or media services. For instance, data file 110 can store information pertaining to a user's Facebook account, and facilitate user-login to the Facebook account through data network 106 at least in part via network-enabled television 102 and network authentication system 104. Other communication or media service account information can be stored in data file 110 as well, including e-mail account information, Twitter or other social media account information, mobile communication account information, and so on. In a particular aspect, rules related to billing and charging services, content access, content distribution, etc., associated with the respective accounts established by shared billing or content agreements between respective service providers can be stored in data file 110, so that content accessed through one or more accounts stored on data file 110 can be in accordance with those rules, and charging and billing functionality can be in accordance with those rules as well. In another aspect, rules established by an aggregate provider for a combination of media services (e.g., a provider that offers any suitable subset of television, Internet service, and mobile communications services, for instance) can be stored separate from any rules derived from shared content agreements. Further, data file 110 can store associations between user accounts, service provider agreements related to those accounts, and respective service provider rules and agreements affecting content consumed by respective accounts. Thus, data store 108 can store information facilitating simple or complex arrangements of content access and availability, and associated billing costs and rates, for a single content provider, an aggregate content provider, or multiple content providers, for different accounts having different agreements with one or more of the providers and types of providers.

In response to receiving the logon and authentication query, network data store 108 can send a logon status to network authentication system 104. The logon status can include data that indicates whether one or more associated user accounts is logged on or otherwise currently authenticated. If so, the response can also include user account profile information stored in a user profile 112 on network data store 112. User profile 112 can store user preference parameters for various user accounts associated with network-enabled television 102. Suitable user preference parameters can include accessible media content (e.g., accessible channels, media titles, etc.), content controls (e.g., parental access controls), operation controls (e.g., limits or permissions for access to configuration functions of network-enabled television 102), a preferred genre or other type of media content, a preferred media format (e.g., video media, audio media, multimedia, . . . ), various time of day related preferences (e.g., a genre for a particular time of day), day of the week related preferences, or the like, or a suitable combination thereof. Network data store 108 can be configured to automatically pass any suitable subset of user profile information stored in user profile 112 pertaining to a logged-on account, within the response containing the login status.

If one or more accounts are active, network authentication system 104 can be configured to load user profile information on network-enabled television 102, activating a user account thereon. The user profile information can be utilized to govern access to or display of television content (or other communication or media content) associated with the logged-on account. If no accounts are active, network authentication system 104 can be configured to generate and transmit an authentication message 114 over data network 106 to a communication server/network associated with a default user account. The default user account and addressing/routing information required to send the message can be retrieved by network authentication system 104 from network data store 108 (or, e.g., can be retrieved from a local data store connected to network authentication system 104—not depicted). Authentication message 114 can include personal identification data for logging onto a default account associated with network-enabled television 102. In various aspects, authentication message 114 can be an e-mail message transmitted to an e-mail server, a text message transmitted to a text messaging server, a short message service (SMS) message transmitted to a mobile network providing SMS services, a multimedia message service (MMS) message transmitted to a mobile network providing MMS services, a forum message posted on a forum website or other user account website, a social media message transmitted to a social media server, or the like, or a suitable combination thereof.

In one or more alternative aspects, authentication message 114 can provide log-on information for an aggregate of accounts associated with a user. These accounts can comprise a set of media or communication accounts stored in data file 110, as described above. The log-on information can optionally be utilized to log a user onto all accounts associated with the user within data file 110. For instance, where a user maintains a Facebook account, mobile subscriber account, and television content account within data file 110, a common set of log-on data can be stored in data file 110 for purposes of logging the user into all of these accounts concurrently. As a further option, the user can store different sets of log-on data configured to log the user into a subset of the accounts associated with the user. For instance, a first subset of log-on data can log the user only into the television content account, whereas a second subset of log-on data can log the user only into the Facebook account, whereas a third subset of log-on data can log the user into all three accounts, and so on, or other suitable combinations thereof. According to additional aspects, data file 110 can store a login status for each account separately from other accounts. In this case, where the user logs into one account but not into another, turning on network-enabled television 102 can cause network authentication system 104 to identify the logged on account and provide communication or content services for that account, but not the non-logged on accounts. Authentication message 114 can be configured, in this instance, to include log-on information associated with non-logged on accounts of the user, which can include separate log-on data for separate accounts, a set of log-on data configured to log the user into all associated accounts, or the like. Once logged into additional accounts, content associated with those accounts can be made available at least in part via network-enabled television 102, as described in more detail below.

Upon transmitting authentication message 114, network authentication system 104 can cause network-enabled television 102 to output a data input field 118 on a video/graphical display screen 116 of network-enabled television 102. User input data responsive to data input field 118 can be received via suitable user input device (e.g., remote control, button press on network-enabled television, . . . ) and compared with the personal identification data transmitted with authentication message 114. If the user input data matches the personal identification data, network-enabled television 102 can log onto a default user account, and obtain user preferences for the default user account from user profile 112. A user can then access and playback media associated with the default user account (e.g., a television program), access configuration and settings parameters of network-enabled television that are authorized to the default user account, switch accounts to a user account other than the default user account (e.g., by providing log-on information for the other user account), and so on.

In some aspects of the subject disclosure, user input data can be received in response to authentication message 114, instead of being entered into data input field 118. For instance, a reply message can be received in response to authentication message 114 from the communication server or network to which authentication message 114 was sent. If the reply message includes a suitable set of authentication data (e.g., the personal identification data, a password, a personal identification number (PIN), . . . ), network authentication system 104 can authenticate a user account associated with the suitable set of authentication data, terminate graphical input field 118, load user profile information from user profile 112 associated with the authenticated user account, and allow access to media, settings, content, etc., on network-enabled television 102 associated with the authenticated user account.

System 100 provides significant benefits over conventional network-enabled television systems. For instance, system 100 can facilitate automated login and authentication of a user account associated with the network-enabled television 102. Once the television is powered-on, system 100 can automatically check user account authentication, and load user account profile information associated with a pre-authenticated user account. If no pre-authenticated user account is available, a message can be sent to a stored communication/network account, such as to a mobile phone account, an e-mail account, etc., facilitating user authentication. A response input into the network-enabled television 102, or sent in reply to the message, (a reply mobile phone message, e-mail message, text message, . . . ) can be utilized to authenticate or activate a user account, and load preferences associated with the user account. Thus, system 100 can provide a quick and convenient mechanism for accessing an account associated with a network-enabled television 102.

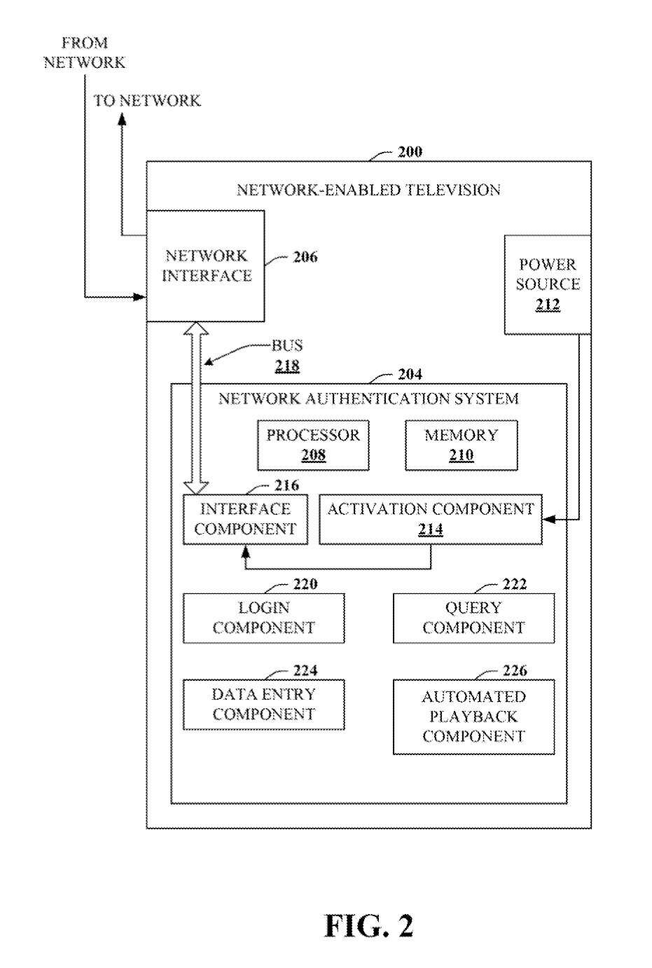

FIG. 2 depicts a block diagram of an example network-enabled television 200 configured to provide automated account authentication and content filtering according to various aspects of the subject disclosure. Network-enabled television 202 can comprise a network interface 206 for communicatively connecting network-enabled television 202 to a data network. Network interface 206 can comprise a wired interface, in some aspects of the subject disclosure (e.g., Ethernet, universal serial bus (USB), high definition multimedia interface (HDMI), . . . ), a wireless interface (e.g., Wi-Fi®, WiMAX, cellular, BlueTooth®, Zigbee®, . . . ), or a suitable combination of wired and wireless interfaces. The data network can include, in at least one aspect, the Internet, a mobile communication network, a local area network, a wide area network, an intranet, or the like, or a suitable combination thereof.

In addition to the foregoing, network-enabled television 200 can comprise a network authentication system 204 that can be configured to provide user authentication, media content filtering, or automated playback functionality, as described herein. Network authentication system 204 can comprise a processor 208 configured to perform one or more functionality or configurations of network authentication system 204, in response to instructions stored in a memory 210. Processor 208 and memory 210 can be any suitable processor and memory device, and can comprise multiple processors and multiple memories, where suitable.

Network authentication system 200 can comprise an activation component 214 configured to receive a signal from a power source 212 of network-enabled television 200, in response to a power-up of the network-enabled television 200. In response to receiving the signal, activation component 214 can trigger an interface component, which can be configured to automatically access a network data store over a communication network (e.g., the data network) associated with network-enabled television. For instance, interface component 216 can access network interface 206 through a communication bus 218 communicatively connecting network interface 206 and network authentication system 204. Through communication bus 218, interface component 216 can send and receive data to/from the network data store located on the data network.

Upon accessing the network data store, a login component 220 configured to employ the interface component 216 can retrieve data from the network data store that is indicative of an authorization status of a set of user accounts associated with network-enabled television 200. Login component 220 can identify any user accounts that have a positive authorization status (or pre-authorized, etc.). Login component 220 can be configured to access and load profile information (e.g., account settings, media content filtering, configuration controls, and so on) associated with an activated account(s) onto network-enable television 200. In some aspects, once profile information is loaded, media content filtering and auto playback can be initiated, as described in more detail below.

In login component 220 determines that no user account has positive authorization status, no user account information is loaded for network-enabled television 200. A query component 222 can be employed that is configured to transmit, in response to data indicating a negative authorization status for the set of user accounts associated with network-enabled television 200, an authorization message to a mobile device account associated with at least one of the set of user accounts. The authorization message can comprise authorization data configured to authenticate an identity of a user of one or more of the set of user accounts.

In conjunction with sending the message, a data entry component 224 can be configured to provide an input field on a display of network-enabled television 200. Data entry component 224 can be further configured to receive a set of user input data from a user input device (e.g., a remote control) associated with the network-enabled television. Data entry component 224 can be further configured to compare the set of user input data to the authorization data, and authenticate an identity of a user of at least one of the set of user accounts in response to the set of user data matching the authorization data. If the set of user input data does not match the authorization data, data entry component 224 can be further configured to compare the set of user input data to a set of authorization data having respective subsets of authorization data associated with respective ones of a set of user accounts. Moreover, data entry component 224 can be configured to authenticate an identity of another user (e.g., a user having a different user account, a user sharing a user account(s) associated with the at least one of the set of user accounts and the mobile device account, etc.) in response to the set of user input data matching one of the respective subsets of authorization data, and authorize or log the user into an associated respective one of the set of user accounts associated with the one of the respective subsets of the authorization data. Once this user is logged in, profile information and user preferences (if any) related to the respective one of the set of user accounts can be loaded onto network-enabled television 200, to facilitate identifying preferred media content for the user, providing access to functionality, configurations and settings of network-enabled television 200 associated with the user, and so on.

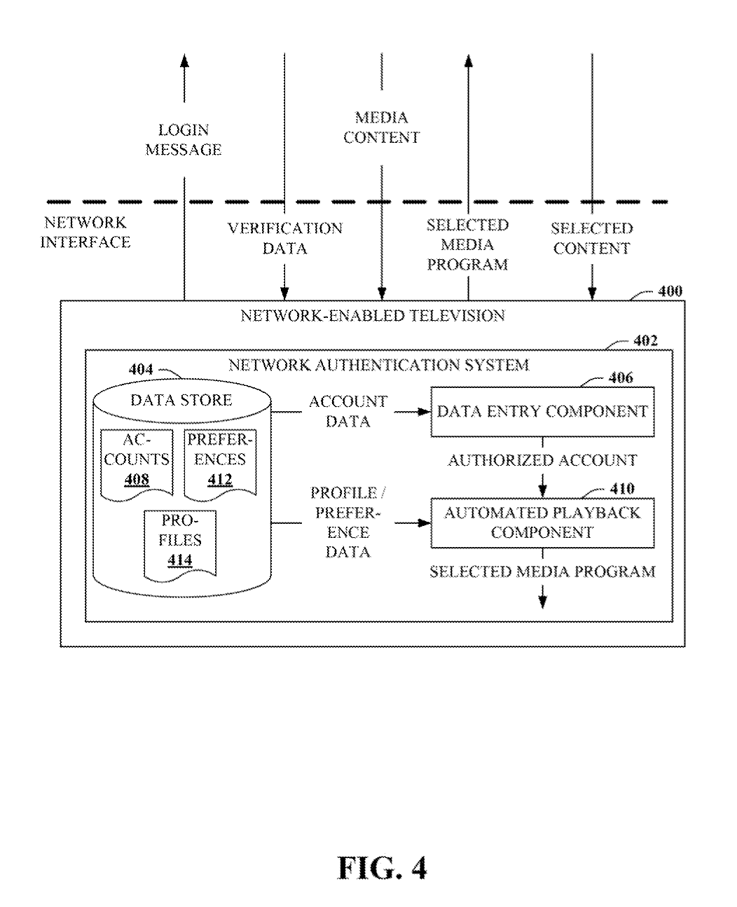

As depicted, network-enabled television 200 can further comprise an automated playback component 226. Automated playback component 226 can be configured to reference a user profile, or user profile information loaded onto network-enabled television, for an authenticated user of network-enabled television. Further, automated playback component 226 can be configured to filter available content from a content provider (e.g., television programming) utilizing one or more stored parameters of the user profile. The stored parameters can relate to a preferred genre(s) of content, a preferred show title, a preferred type of show (e.g., sitcom, movie, news and current events, . . . ), and can be based on usage history associated with the authenticated user. Moreover, automated playback component 226 can be configured to select a subset of preferred media programs from the available content that result from the filtering, and to automatically playback one or more of the subset of preferred media programs. In a particular aspect, stored user preference selections or user preference input data can be utilized to select a particular media program from the preferred media programs, and automatically play the selected media program in response to network-enabled television being powered-on—if a user account is pre-authorized, or in response to authorizing such an account and loading profile or preference information of such account (e.g., see FIG. 4, infra).

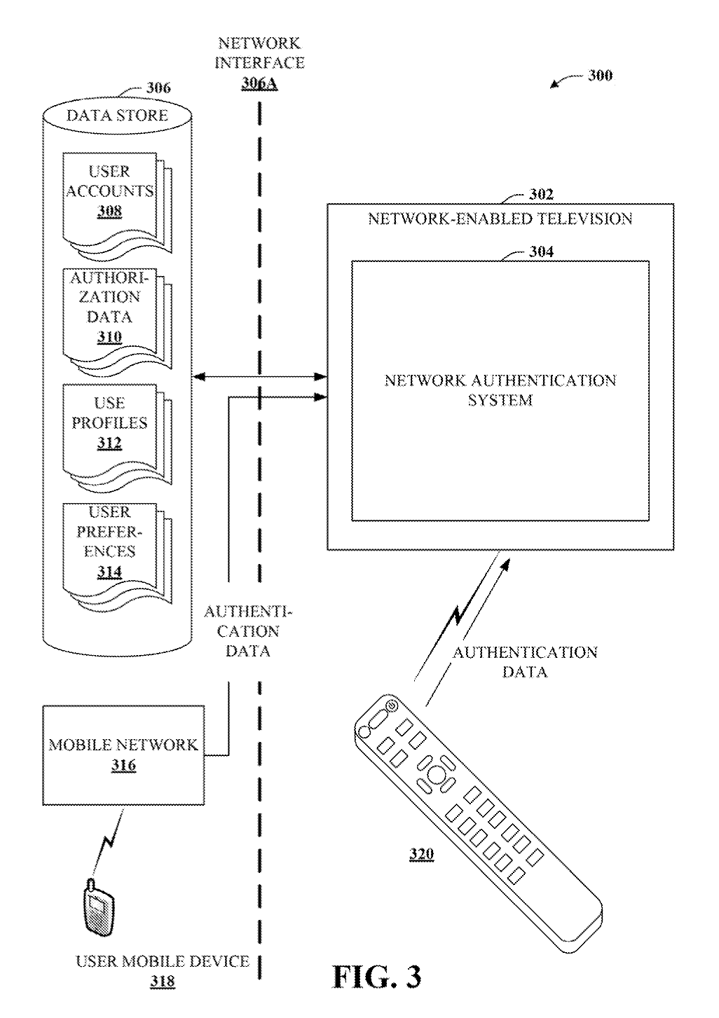

FIG. 3 depicts a block diagram of an example system 300 configured for automated authentication of user account information for a network-enabled television, according to one or more other aspects of the subject disclosure. System 300 can comprise a network-enabled television 302 communicatively connected to a network data store 306 via a network interface 306A. In response to a power-on event for network-enabled television 302, a network authentication system can automatically initiate a communication session over network interface 306A and access network data store 306. Further, network authorization system 304 can access data stored in an authorization data file 310 and determine whether one or more user accounts associated with network-enabled television 302 are pre-authorized (e.g., based on prior provision of personal identification data, a password, a PIN, or the like, or a status of such event, stored in authorization data file 310). If a single user account is pre-authorized, network authentication system 304 can be configured to identify the authorized user account from data stored in user account file 308, and reference user preference information for the single user account from user preference file 314, and load the user preference information onto network-enabled television 302. In some aspects, network authentication system 304 can be configured to further load account profile information (e.g., parental control status, configuration/settings access level, accessible media content, . . . ) from user accounts file 308 onto network-enabled television as well, as described herein. In other aspects, user use profile information in a use profile 312 can be loaded onto network-enabled television 302, to facilitate filtering preferred media content, or identifying a selected media program for automated viewing, based at least in part on the user use profile information. It should be appreciated that use profile 312 can store respective use profiles for respective user accounts, authorization data file 310 can store respective sets of authorization data for the respective user accounts (or aggregates of those user accounts, in the case where log-on data is configured to log a user on to multiple accounts for that user), and user preference file 314 can store respective user preference information for the respective user accounts. Thus, where a particular user or account is identified by network authorization system 304, a user profile, authorization data and preference information can be accessed for the particular user or account. Likewise, where another user or account is identified, profile, authorization data and preference information for the other user or account can be retrieved to facilitate functions described herein, where suitable.

In the event that network authentication system 304 retrieves data from authorization data file 310 indicating multiple user accounts are pre-authorized, a process for selecting one of the multiple user accounts can be initiated. In one aspect, the process can comprise referencing user accounts file 308 and identifying a default user account, and load user preference or account profile information associated with the default user account. In an alternative, or additional aspect, the process can comprise displaying a user input data field onto a display screen of network-enabled television 302. User input from a remote control 320 can be utilized to select one of the multiple user accounts for loading onto network-enabled television 302.

In the event that network authorization system 304 determines that no user account is pre-authorized for network-enabled television 302, a message (e.g., e-mail, text mail, voice mail, SMS, MMS, social network message, social media website page, . . . ) can be generated and transmitted, comprising personal identification data. The personal identification data can include a PIN, a password, an account name, or the like, or a suitable combination thereof. In at least one aspect, the personal identification data can comprise a sequence of key presses of remote control 320. As one illustrative example, if remote control 302 includes a playback, skip back, skip forward, pause and stop playback buttons (among others), the personal identification data can comprise a sequence of these buttons. This can provide a much more user-friendly code entry system, than displaying an alphabet, numbering system, or the like on the display, and requiring a user authenticate with such methods.

In a particular aspect of the subject disclosure, the message generated and transmitted by network authentication system 304 can comprise a mobile network message (e.g., text, SMS, MMS, . . . ) transmitted to a mobile network 316 and addressed for a user mobile device 318. In this case, the message could include authentication data configured for easy entry on a user interface of user mobile device 318. The configuration can be particular to a single user mobile device 318 (e.g., having user-assigned key functionality), a particular type or class of user mobile device (e.g., having a particular keyboard), a particular manufacturer of user mobile device 318, and so forth. Accordingly, the configuration can facilitate ease of entry, depending on hardware or software peculiarities of user mobile device 318.

In at least one further aspect, distribution of the message can be by one of various methods. In a first aspect, network authentication system 304 can distribute the message to one or more default mobile devices (e.g., mobile device 318) associated with account log-in. In a second aspect, network authentication system 304 can instead receive information identifying a user, retrieve an account associated with the user, and distribute the message to a mobile device stored in relation to the account associated with the user. In this aspect, a user could provide some input on remote control 320 identifying the user, and the message can include personal identification data sent to the mobile device for the purposes of verifying that identity. In a third aspect, upon receiving authentication data from network-enabled television 302, mobile network 316 can be configured to acquire position locations of mobile devices (e.g., by network-generated position location, mobile device generated position location, . . . ,) within a predetermined or user-established distance of network-enabled television 302. Those mobile devices within such distance, and that are stored in data store 306 in association with one or more user accounts or default accounts, can be sent the message. Thus, mobile network 316 can be employed to discriminately send the message only to devices within a certain range of network-enabled television. In a fourth aspect, network authentication system 304 can transmit the message to all mobile devices stored in data store 306 in associated with the one or more user accounts or default accounts.

Upon entering the authentication data, a reply message is sent to network-enabled television 302 and retrieved by network authentication system 304. If the authentication data matches stored authentication data, an associated user account, user preferences, account profile, filtered media content, etc., can be loaded onto network-enabled television 302 to simplify the logon and media selection experience of a user of network-enables television 302.

In at least one aspect of the subject disclosure, a message sent by network authentication system 304 over a particular media type (e.g., mobile network, e-mail server, user data input field on a display on network-enabled television 302, . . . ) can be replied over a different media type. For instance, a code sent in an SMS message can be entered by remote control 320 into a user data input field on network-enabled television 302, instead of via data entry on user mobile device 318. In another instance, the reverse can be implemented, and so on.

FIG. 4 illustrates a block diagram of an example network-enabled television 400. Particularly, network-enabled television 400 is depicted in conjunction with an automated account authorization mechanism, according to at least one aspect of the subject disclosure. Moreover, network-enabled television is depicted in conjunction with an automated media program selection and playback function, according to one or more other aspects of the subject disclosure. The automated account authorization functionality and automated media program selection and playback functionality can be configured to improve user experience of network-enabled television 400, by minimizing overhead time involved in logging into a user account, and reducing search time for locating and selecting desired media content for viewing.

Network-enabled television 400 can comprise a network authentication system 402 having a data store 404 for storing information pertaining to one or more users, or one or more user accounts for network-enabled television 400. To authorize user accounts for future user use, network authentication system 402 can transmit a login message to an electronic communication account stored in data store 404. The electronic communication account can include an e-mail account, mobile phone account, social media account, or the like, or a suitable combination thereof. The login message includes authentication data associated with verifying identity of a user(s) of the one or more user accounts. In response to the login message, network-enabled television 400 can receive a set of user input data in response. A data entry component 406 can be configured to compare the user input data with security, password, login, authorization, etc., information related to the one or more user accounts. Data entry component 406 can determine whether the user input data matches any information related to the user accounts, and authorize an account matching the user input data. If the user input data does not match stored account information, authorization is denied.

Upon authorizing a user account, data entry component 406 can provide information identifying the authorized account to an automated playback component 410. Utilizing the identifying information, automated playback component 410 can access data store 404 and extract user preference data for the authorized account from a user preferences file 412, and account profile data for the authorized account from an account profile 414. Additionally, automated playback component 410 can receive a listing of available media content associated with the authorized account. The media content can include media content configured for the authorized account by a content service provider, for instance. Automated playback component 410 can compare information related to the media content (e.g., metadata information, or the like) to account profile information, and filter a subset of the media content based on one or more parameters within the account profile information. In at least one aspect, account profile information can contain usage history information derived from patterns of media playback associated with the authorized account. The usage history information can identify one or more programs, genres, types of programs, etc., often selected by a user of the authorized account. This information can be utilized to filter the subset of the media content from a superset of the media content.

Further to the above, automated playback component 410 can further filter the subset of the media content based on the user preference information. User provided user preferences for a favorite, preferred, non-preferred, disliked, etc., program, type of program, genre, and so forth, can be employed in selecting a media program of the subset of the media content. Automated playback component 410 can then initiate playback of the selected media program on a main display of network-enabled television 400. Accordingly, network authentication system 402 can enable automated authentication and login of a user account, automated content filtering, and playback of a selected media program chosen from available media content with reference to user usage history and user preferences as a filtering mechanism for the media content.

According to a particular aspect of the subject disclosure, one or more media programs of the subset of the media content can be displayed on a portion of a display screen of network-enabled television 400. For instance, a graphical, pictorial or video clip of respective media programs can be displayed within respective display icons in the portion of the display screen. A user input selection can facilitate display of different subsets of display icons, depicting different media programs of the subset of media content. Moreover, a user selection of one of the display icons can initiate playback of an associated media program. If automated playback of a media program selected by automated playback component 410 has already been initiated, automated playback component 410 can be configured to terminate the automated playback, and initiate the playback of the user selected media program.

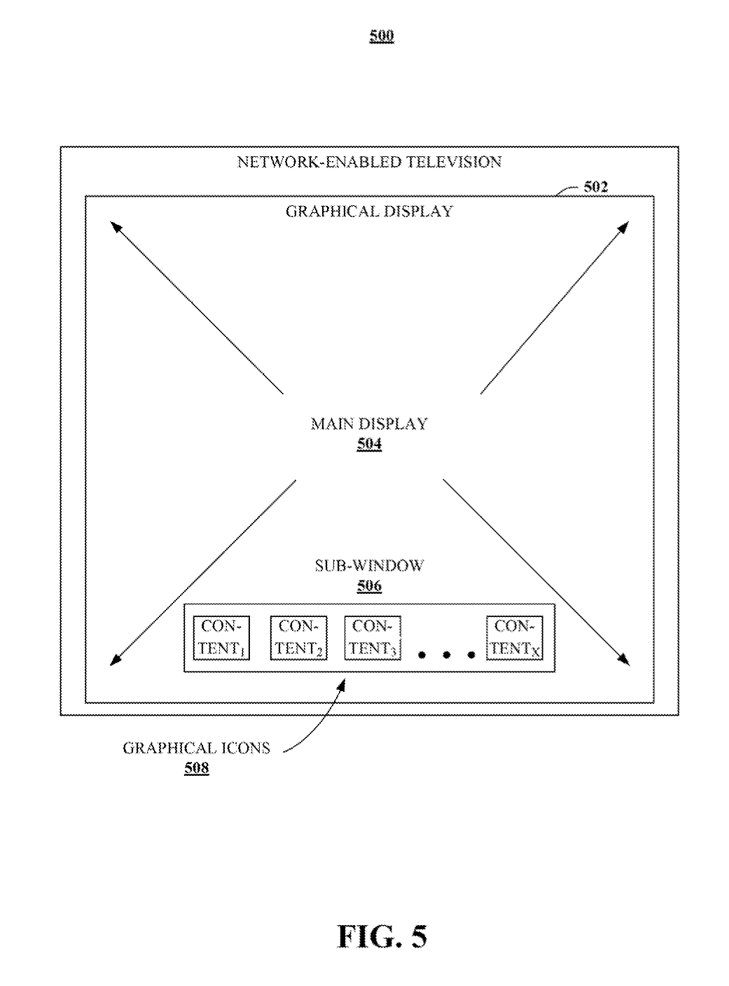

FIG. 5 illustrates a block diagram of an example network-enabled television 500 according to one or more additional aspects of the subject disclosure. Network-enabled television 500 can comprise a graphical display 502, in which graphical or video media is presented or played for user consumption. A media program selected for playback can be displayed in a main window 504 of graphical display 502. According to various aspects of the subject disclosure, the selected media program can be a user selected media program, or a media program selected by a component of network-enabled television 500. Additionally, preferred content filtered from available media programming (e.g., based on user usage patterns, user preferences, or the like, as described herein) can be depicted within a sub-window 506 displayed within a portion of main display 504. Sub-window 506 can include a set of graphical icons, having a graphical representation of respective media programs of the preferred content, including content₁, content₂, content₃ . . . content_{X}, where X is a suitable positive integer. Additional graphical icons can be hidden from sub-window 506 and brought into display at sub-window 506 by navigation commands on a remote control, for instance. A selection of content associated with one of the graphical icons 508 can replace any other media program being played at main display 504 with the selected content. Thus, sub-window 506 can provide quick viewing of respective media programs of the preferred content, as well as efficient selection and playback of a content represented by a selected graphical icon 508.

The aforementioned diagrams have been described with respect to interaction between several systems, apparatuses, components, user interfaces, and display indicators. It should be appreciated that such diagrams can include those components or systems specified therein, some of the specified components, or additional components. For example, a system could include network-enabled television 200 comprising network authentication system 204, and data store 404. Sub-components could also be implemented as components electrically connected to other sub-components rather than included within a parent component. Additionally, it should be noted that two or more components could be combined into a single component providing aggregate functionality. For instance, activation component 214 can include interface component 216 to facilitate receiving a power-on signal and initiating a communication session on a network over network interface 206, by way of a single component. Components of the disclosed systems and apparatuses can also interact with one or more other components not specifically described herein but known by those of skill in the art, or made known to one of skill in the art by way of the context provided herein.

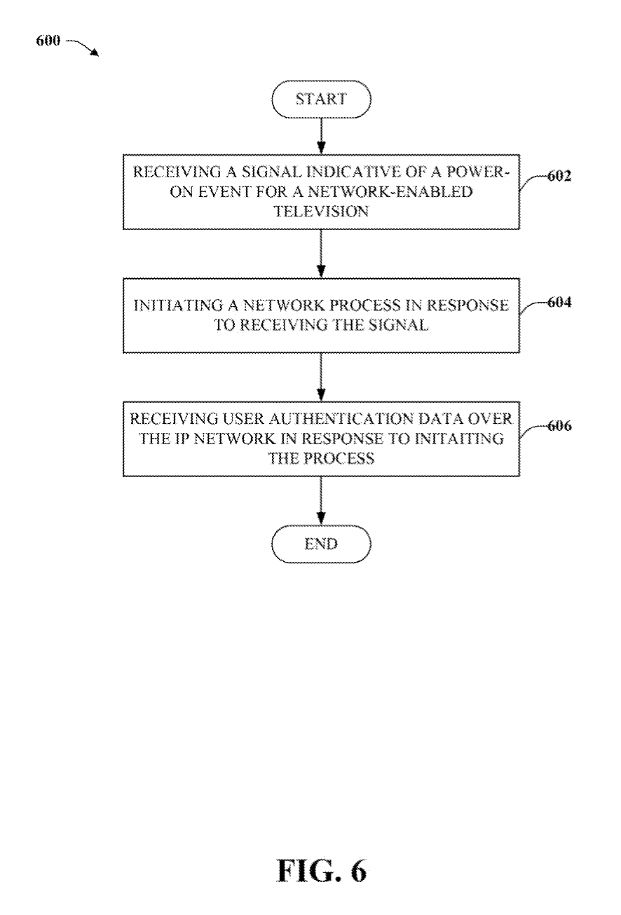

In view of the exemplary diagrams described supra, process methods that may be implemented in accordance with the disclosed subject matter will be better appreciated with reference to the flow chart of FIGS. 6-8. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Additionally, it should be further appreciated that the methods disclosed hereinafter and throughout this specification are capable of being stored on an article of manufacture to facilitate transporting and transferring such methods to an electronic device. The term article of manufacture, as used, is intended to encompass a computer program accessible from any computer-readable device, device in conjunction with a carrier, or storage medium.

FIG. 6 depicts a flowchart of a sample method 600 for providing automated authentication for video on demand services, according to one or more additional aspects of the subject disclosure. At 602, method 600 can comprise receiving a signal indicative of a power-on event from an electronic component of a network-enabled television. At 604, method 600 can comprise initiating a network process in response to receiving the signal, where the network process can in turn be conducted at least in part over an IP network. As one example, initiating the network process can further comprise executing an authentication process for the user account. At 606, method 600 can comprise receiving user authorization data over the IP network in response to initiating the network process. Particularly, the user authentication data can be indicative of an identity of a user registered with a user account maintained by a content provider of the network-enabled television.

In some aspects, executing the authentication process can further comprise sending user authentication data to an electronic communication account associated with the user account. In these aspects, receiving the user authentication data can further comprise receiving the user authentication data from the electronic communication account in response to verification of the identity of the user by the electronic communication account.

In other disclosed aspects, method 600 can additionally comprise displaying a request for user input of the user authentication data in response to receiving the user authentication data over the IP network. In still other aspects, method 600 can further comprise receiving a set of user input data in response to the request, and either granting access to content associated with the user account in response to the set of user input data matching the user authentication data, or denying access to the content associated with the user account in response to the set of user input data matching the user authentication data. In one aspect, receiving the set of user input data can comprise receiving the set of user input data via a user input device associated with the network-enabled television (e.g., a remote control, . . . ). In another aspect, receiving the set of user input data can comprise receiving the set of user input data via the IP network from an electronic communication account (e.g., a mobile network subscriber account, an e-mail account, a Twitter® account, Facebook® account, . . . ) associated with the user account. In still further aspect, method 600 can comprise referencing a content profile associated with the user account and retrieving preferred content information associated with the user profile in response to granting access to content associated with the user account. Additionally, the method can comprise referencing service provider content associated with the user account, identifying a subset of the service provider content that satisfies a condition associated with the preferred content information. In response to identifying the subset of the service provider content, the method can comprise selecting a media program from the subset of the service provider content, and tuning the network-enabled television to a channel or source of the media program, to facilitate automatic playback of the media program on the network-enabled television. In a particular aspect, selecting the media content can further comprise referencing a stored user profile associated with the user account and filtering the subset of the service provider content with one or more content filtering parameters of the stored user profile.

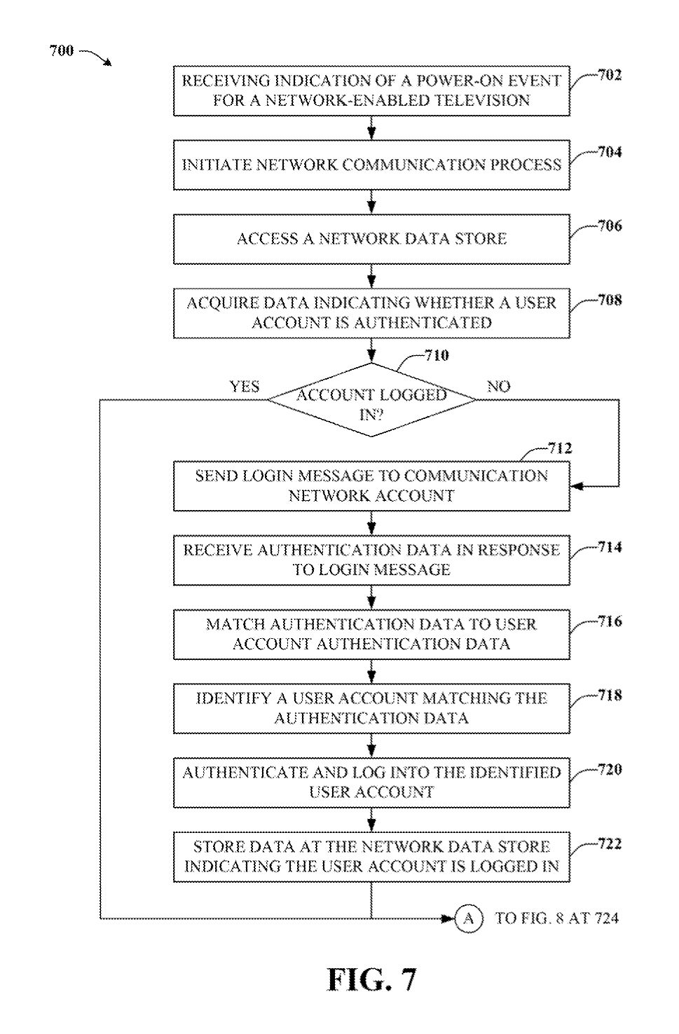

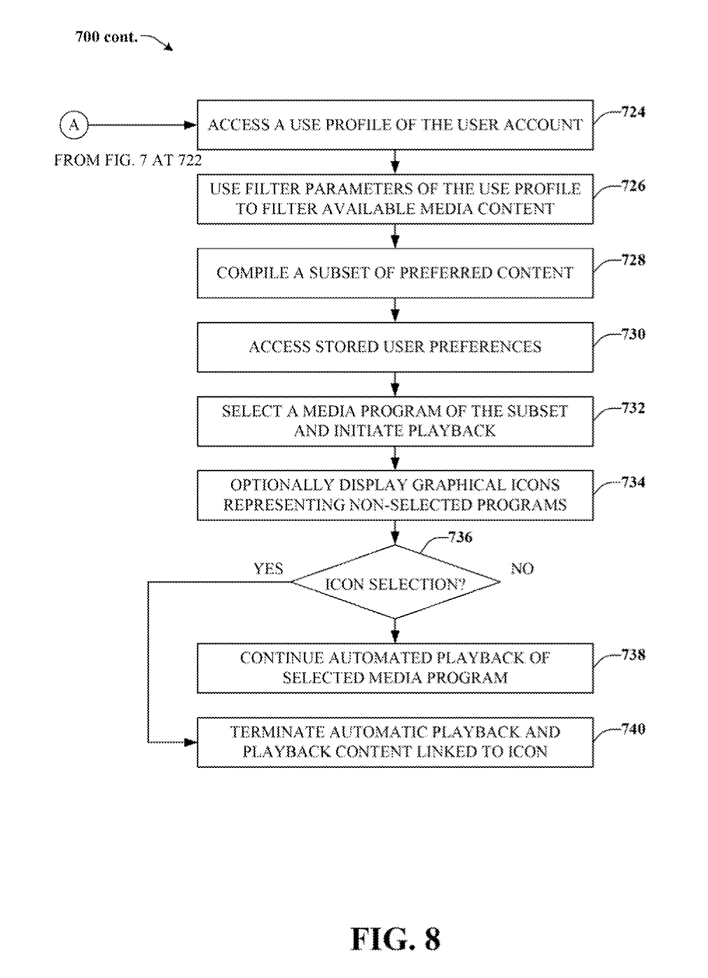

FIGS. 7 and 8 illustrate a flowchart of an example method 700 according to one or more additional aspects of the subject disclosure. At 702, method 700 can comprise receiving an indication of a power-on event for network-enabled television. At 704, method 700 can comprise initiating a network communication session in response to receiving the indication of the power-on event. At 706, method 700 can comprise access a network data store utilizing the network communication session. At 708, method 700 can comprise acquiring data indicating whether a user account is currently authenticated for the network-enabled television. At 710, a determination is made as to whether an account is currently logged in or authenticated. If not, method 700 can proceed to 712. Otherwise, method 700 can proceed to 724 at FIG. 8, infra.

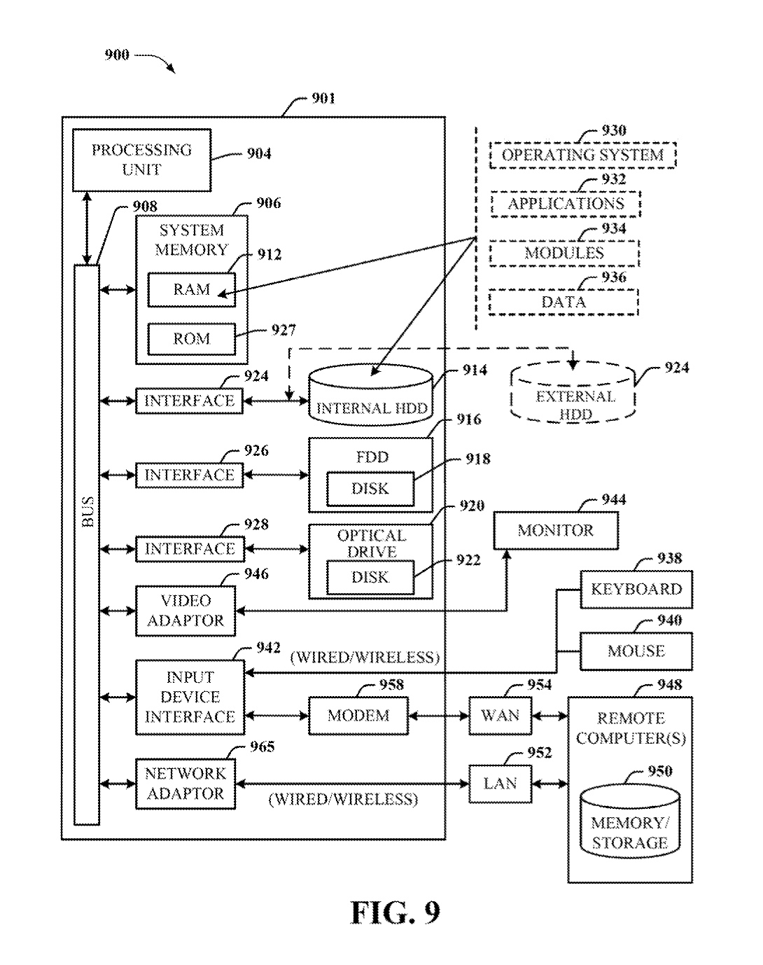

At 712, method 700 can comprise sending a login message to a communication network account (e.g., mobile phone, SMS, MMS, text, e-mail, . . . ) associated with the network-enabled television. At 714, method 700 can comprise receiving authentication data in response to the login message. The authentication data can be received in a user input field of the network-enabled television, or alternatively in from the communication network account in response to the login message. At 716, method 700 can comprise matching the received authentication data to user account authentication data stored in the network data store. At 718, method 700 can comprise identifying a user account matching the authentication data. At 720, method 700 can comprise authenticating the user account and logging a user into the user account in response to the authentication data matching user account authentication data. At 722, method 700 can comprise storing data at the network data store indicating pre-authorization of the user account for reference in regard to a subsequent power-on event for the network-enabled television. From 722, method 700 can proceed to 724 at FIG. 9.

Referring now to FIG. 8, method 700 continues at 724. As depicted, at 724 method 700 can comprise accessing a use profile associated with the user account. At 726, method 700 can comprise utilizing a filtering parameter(s) of the user profile to filter available media content. At 728, method 700 can comprise compiling a subset of preferred content from the results of the filtering. At 730, method 700 can comprise accessing stored user preferences for the user account. At 732, method 700 can comprise selecting a media program of the subset of preferred content and initiating automated playback of the selected media program. At 734, method 700 can optionally comprise displaying, within a portion of a display of the network-enabled television, a graphical reference to respective programs of the preferred content, or a graphical reference to the preferred content in general, and facilitating user selection of a media program represented by one of the graphical references. At 736, a determination can be made as to whether such a selection is received. If not, method 700 proceeds to 738 and continues automated playback of the selected media program. Otherwise, method 700 proceeds to 740, and terminates playback of the selected media program and initiates playback of a media program associated with the graphical reference.

With reference to FIG. 9, an exemplary environment 900 for implementing various aspects described herein includes a computer 902, the computer 902 including a processing unit 904, a system memory 906 and a system bus 908. The system bus 908 connects system components including, but not limited to, the system memory 906 to the processing unit 904. The processing unit 904 can be any of various commercially available processors. Dual microprocessors and other multi processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 can also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 911 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 994 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is to be appreciated that aspects of the subject disclosure can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 2394 serial port, a game port, a USB port, an IR interface, etc.

A monitor 944 or other type of display device is also connected to the system bus 908 through an interface, such as a video adapter 946. In addition to the monitor 944, a computer typically includes other peripheral output devices (not shown), such as speakers, printers, etc.

The computer 902 can operate in a networked environment using logical connections by wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or can be connected to a communications server on the WAN 954, or has other means for establishing communications over the WAN 954, such as by way of the Internet. The modem 958, which can be internal or external and a wired or wireless device, is connected to the system bus 908 through the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi® and Bluetooth™ wireless technologies. Thus, the communication can be a predefined structure as with a conventional network or simply an ad hoc communication between at least two devices.

Wi-Fi, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), or other bands (e.g., 802.11g, 802.11n, . . . ) so the networks can provide real-world performance similar to the basic 10BaseT wired Ethernet networks used in many offices.

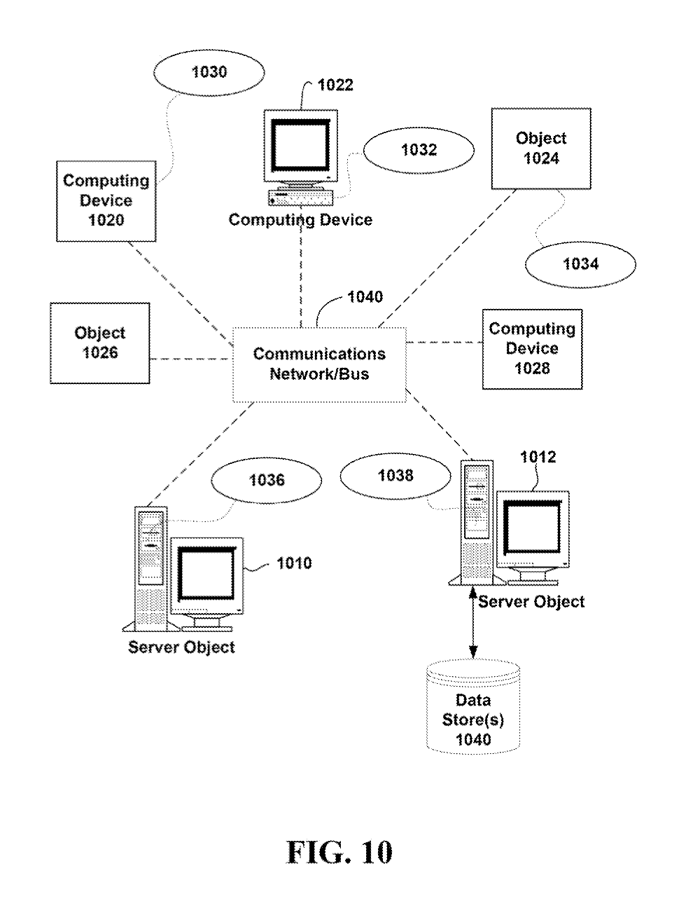

FIG. 10 provides a schematic diagram of an exemplary networked or distributed computing environment. The distributed computing environment comprises computing objects 1010, 1012, etc. and computing objects or devices 1020, 1022, 1024, 1026, 1028, etc., which may include programs, methods, data stores, programmable logic, etc., as represented by applications 1030, 1032, 1034, 1036, 1038 and data store(s) 1040. It can be appreciated that computing objects 1010, 1012, etc. and computing objects or devices 1020, 1022, 1024, 1026, 1028, etc. may comprise different devices, including network-enabled television 102, 200, 302, 400, 500, or other devices such as a mobile phone, personal digital assistant (PDA), audio/video device, MP3 players, personal computer, laptop, etc. It should be further appreciated that data store(s) 1040 can include network data store 108, 306, or in some cases data store 404.

Each computing object 1010, 1012, etc. and computing objects or devices 1020, 1022, 1024, 1026, 1028, etc. can communicate with one or more other computing objects 1010, 1012, etc. and computing objects or devices 1020, 1022, 1024, 1026, 1028, etc. by way of the communications network 1042, either directly or indirectly. Even though illustrated as a single element in FIG. 10, communications network 1042 may comprise other computing objects and computing devices that provide services to the system of FIG. 10, and/or may represent multiple interconnected networks, which are not shown. Each computing object 1010, 1012, etc. or computing object or devices 1020, 1022, 1024, 1026, 1028, etc. can also contain an application, such as applications 1030, 1032, 1034, 1036, 1038, that might make use of an API, or other object, software, firmware and/or hardware, suitable for communication with or implementation of the techniques for search augmented menu and configuration functions provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems for search augmented menu and configuration functions as described in various embodiments.

Thus, a host of network topologies and network infrastructures, such as client/server, peer-to-peer, or hybrid architectures, can be utilized. One or more of these network topologies can be employed by network-enabled television 102, 200, 302, 400, 500 for communicating with a network. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 10, as a non-limiting example, computing objects or devices 1020, 1022, 1024, 1026, 1028, etc. can be thought of as clients and computing objects 1010, 1012, etc. can be thought of as servers where computing objects 1010, 1012, etc., acting as servers provide data services, such as receiving data from client computing objects or devices 1020, 1022, 1024, 1026, 1028, etc., storing of data, processing of data, transmitting data to client computing objects or devices 1020, 1022, 1024, 1026, 1028, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1042 or bus is the Internet, for example, the computing objects 1010, 1012, etc. can be Web servers with which other computing objects or devices 1020, 1022, 1024, 1026, 1028, etc. communicate via any of a number of known protocols, such as the hypertext transfer protocol (HTTP). Computing objects 1010, 1012, etc. acting as servers may also serve as clients, e.g., computing objects or devices 1020, 1022, 1024, 1026, 1028, etc., as may be characteristic of a distributed computing environment.

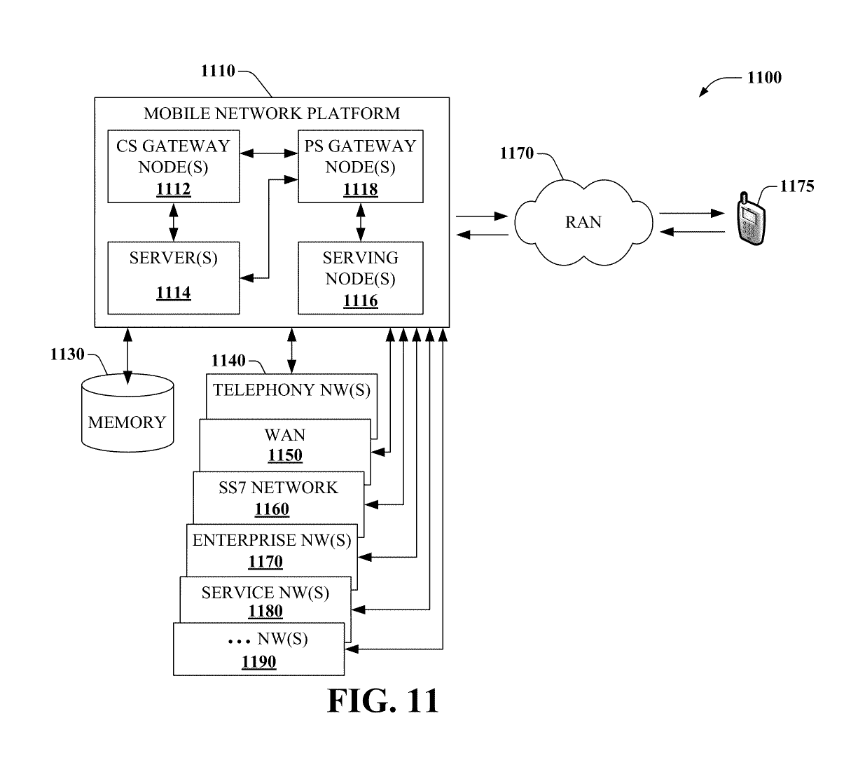

FIG. 11 presents an example embodiment 1100 of a mobile network platform 1110 that can implement and exploit one or more aspects of the disclosed subject matter described herein. Generally, wireless network platform 1110 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. Mobile network platform 1110 includes CS gateway node(s) 1112 which can interface CS traffic received from legacy networks like telephony network(s) 1140 (e.g., public switched telephone network (PSTN), or public land mobile network (PLMN)) or a signaling system #7 (SS7) network 1170. Circuit switched gateway node(s) 1112 can authorize and authenticate traffic (e.g., voice) arising from such networks. Additionally, CS gateway node(s) 1112 can access mobility, or roaming, data generated through SS7 network 1170; for instance, mobility data stored in a visited location register (VLR), which can reside in memory 1130. Moreover, CS gateway node(s) 1112 interfaces CS-based traffic and signaling and PS gateway node(s) 1118. As an example, in a 3GPP UMTS network, CS gateway node(s) 1112 can be realized at least in part in gateway GPRS support node(s) (GGSN). It should be appreciated that functionality and specific operation of CS gateway node(s) 1112, PS gateway node(s) 1118, and serving node(s) 1116, is provided and dictated by radio technology(ies) utilized by mobile network platform 1110 for telecommunication.

In the disclosed subject matter, in addition to receiving and processing CS-switched traffic and signaling, PS gateway node(s) 1118 can authorize and authenticate PS-based data sessions with served mobile devices. Data sessions can include traffic, or content(s), exchanged with networks external to the wireless network platform 1110, like wide area network(s) (WANs) 1150, enterprise network(s) 1170, and service network(s) 1180, which can be embodied in local area network(s) (LANs), as well as other types of networks not herein disclosed 1190, can also be interfaced with mobile network platform 1110 through PS gateway node(s) 1118. It is to be appreciated that mobile network platform 1110 can communicate with network-enabled television 102, 200, 302, 400, 500 via WAN 1150, enterprise network(s) 1170, or service network(s) 1180, where network-enabled television 102, 200, 302, 400, 500 maintains a suitable connection to one or more of the foregoing networks. It is to be further noted that WANs 1150 and enterprise network(s) 1160 can embody, at least in part, a service network(s) like IP multimedia subsystem (IMS). Based on radio technology layer(s) available in technology resource(s) 1117, packet-switched gateway node(s) 1118 can generate packet data protocol contexts when a data session is established; other data structures that facilitate routing of packetized data also can be generated. To that end, in an aspect, PS gateway node(s) 1118 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 1100, wireless network platform 1110 also includes serving node(s) 1116 that, based upon available radio technology layer(s) within technology resource(s) 1117, convey the various packetized flows of data streams received through PS gateway node(s) 1118. It is to be noted that for technology resource(s) 1117 that rely primarily on CS communication, server node(s) can deliver traffic without reliance on PS gateway node(s) 1118; for example, server node(s) can embody at least in part a mobile switching center. As an example, in a 3GPP UMTS network, serving node(s) 1116 can be embodied in serving GPRS support node(s) (SGSN).

For radio technologies that exploit packetized communication, server(s) 1114 in wireless network platform 1110 can execute numerous applications (e.g., location services, online gaming, wireless banking, wireless device management, wireless link characterization, mobile device capability acquisition, . . . ) that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 1110. Data streams (e.g., content(s) that are part of a voice call or data session) can be conveyed to PS gateway node(s) 1118 for authorization/authentication and initiation of a data session, and to serving node(s) 1116 for communication thereafter. In addition to application server, server(s) 1114 can include utility server(s); a utility server can include a provisioning server, an operations and maintenance server, a security server that can implement at least in part a certificate authority and firewalls as well as other security mechanisms, and the like. In an aspect, security server(s) secure communication served through wireless network platform 1110 to ensure network's operation and data integrity in addition to authorization and authentication procedures that CS gateway node(s) 1112 and PS gateway node(s) 1118 can enact. Moreover, provisioning server(s) can provision services from external network(s) like networks operated by a disparate service provider; for instance, WAN 1150 or Global Positioning System (GPS) network(s) (not shown). Provisioning server(s) can also provision coverage through networks associated to wireless network platform 1110 (e.g., deployed and operated by the same service provider), such as Femto cell network(s) (not shown) that enhance wireless service coverage within indoor confined spaces and offload RAN resources in order to enhance subscriber service experience within a home or business environment.

It is to be noted that server(s) 1114 can include one or more processors configured to confer at least in part the functionality of macro network platform 1110. To that end, the one or more processor can execute code instructions stored in memory 1130, for example. It is should be appreciated that server(s) 1114 can include a content manager 1115, which operates in substantially the same manner as described hereinbefore.

In example embodiment 1100, memory 1130 can store information related to operation of wireless network platform 1110. In particular, memory 1130 can include contents of data store 108 in example system 100, data store 306 of example system 300, or data store 404 in example network-enabled television 400. Other operational information can include provisioning information of mobile devices served through wireless platform network 1110, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 1130 can also store information from at least one of telephony network(s) 1140, WAN 1150, enterprise network(s) 1160, or SS7 network 1170.

It is to be noted that aspects, features, or advantages of the disclosed subject matter described in the subject specification can be exploited in substantially any wireless communication technology. For instance, Wi-Fi, WiMAX, Enhanced GPRS, 3GPP LTE, 3GPP2 UMB, 3GPP UMTS, HSPA, HSDPA, HSUPA, GERAN, UTRAN, LTE Advanced. Additionally, substantially all aspects of the disclosed subject matter as disclosed in the subject specification can be exploited in legacy telecommunication technologies; e.g., GSM. In addition, mobile as well non-mobile networks (e.g., internet, data service network such as internet protocol television (IPTV)) can exploit aspects or features described herein.

What has been described above includes examples of systems and methods that provide aspects of the disclosed subject matter. It is, of course, not possible to describe every conceivable combination of components or methodologies for purposes of describing the disclosed subject matter, but one of ordinary skill in the art may recognize that many further combinations and permutations of the subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

1. A method, comprising:
receiving a signal indicative of a power-on event from an electronic component of a network-enabled television;
initiating a network process in response to receiving the signal, the network process is conducted at least in part over an Internet Protocol (IP) network; and
receiving user authorization data over the IP network in response to initiating the network process, the user authorization data is indicative of an identity of a user registered with a user account maintained by a content provider of the network-enabled television.

2. The method of claim 1, wherein initiating the network process further comprises executing an authentication process for the user account.

3. The method of claim 2, wherein executing the authentication process further comprises sending the user authorization data to an electronic communication account associated with the user account.

4. The method of claim 3, wherein receiving the user authentication data further comprises receiving the user authentication data from the electronic communication account in response to verification of the identity of the user by the electronic communication account.

5. The method of claim 1, further comprising displaying a request for user input of the user authorization data in response to receiving the user authentication data over the IP network.

6. The method of claim 5, further comprising receiving a set of user input data in response to the request, and at least one of:
granting access to content associated with the user account in response to the set of user input data matching the user authorization data; or
denying access to content associated with the user account in response to the set of user input data not matching the user authorization data.

7. The method of claim 5, further comprising receiving the set of user input data via a user input device associated with the network-enabled television.

8. The method of claim 5, further comprising receiving the set of user input data via the IP network from an electronic communication account associated with the user account.

9. The method of claim 5, further comprising referencing a content profile associated with the user account and retrieving preferred content information associated with the user profile in response to granting access to content associated with the user account.

10. The method of claim 9, further comprising:
referencing service provider content associated with the user account;
identifying a subset of the service provider content that satisfies a condition associated with the preferred content information;
selecting a media program from the subset of the service provider content; and
tuning the network-enabled television to a channel or source of the media program to facilitate automatic playback of the media program on the network-enabled television.

11. The method of claim 10, further comprising:
selecting a sub-subset of the service provider content;
displaying within a portion of a display of the network-enabled television a graphical reference to the sub-subset of the service provider content, or a graphical reference to one or more additional media programs of the sub-subset of the service provider content; and
facilitating user selection of a second media program represented by the graphical reference, and terminating playback of the media program and initiating playback of the second media program in response to user selection of the second media program.

12. The method of claim 9, wherein selecting the media content further comprises referencing a stored user profile associated with the user account and filtering the subset of the service provider content with one or more content filtering parameters of the stored user profile.

13. A system, comprising:
an activation component configured to receive a signal in response to power-up of a network-enabled television;
an interface component configured to automatically access a network data store over a communication network associated with the network-enabled television;
a login component configured to employ the interface component to retrieve data from the network data store, the data indicative of an authorization status of a set of user accounts associated with the network-enabled television; and
a query component configured to transmit, in response to the data being indicative of a negative authorization status, an authorization message to a mobile device account associated with at least one of the set of user accounts, the authorization message comprises authorization data that enables authentication of an identity of a user of the at least one of the set of user accounts.

14. The system of claim 13, further comprising a data entry component configured to provide an input field on a display of the network-enabled television and configured to receive a set of user input data from a user input device associated with the network-enabled television.

15. The system of claim 14, wherein the data entry component is further configured to compare the set of user input data to the authorization data, and configured to authenticate the identity of the user in response to the set of user data being a match of the authorization data.

16. The system of claim 15, wherein the data entry component is further configured to compare the set of user input data to a set of authorization data associated with respective ones of the set of user accounts in response to the set of user data not being a match of the authorization data, and to authenticate the identity of another user associated with at least one of the set of user accounts, in response to the set of user input data being a match of a subset of the set of authorization data associated with the at least one of the other user accounts.

17. The system of claim 16, further comprising an automated playback component configured to:
reference a user profile of an authenticated user;
filter available content from a content provider associated with the network-enabled television utilizing one or more stored parameters of the user profile;
select a subset of preferred media programs from the available content; and
initiate automated playback of one or more of the subset of preferred media programs.

18. The system of claim 13, wherein the authorization data comprises a personal identification code comprising a sequence of inputs, the inputs representing buttons on a user input device associated with the network-enabled television.

19. The system of claim 16, wherein the user input device is a television remote control, and the buttons comprise buttons associated with operating the network-enabled television.

20. A user interface module for a network-enabled television, comprising:
an interface component configured to initiate communication with a network data store over a network communicatively connected to the network-enabled television in response to activation of the network-enabled television and to determine whether one or more user accounts of the network-enabled television are authenticated;
a playback component configured to automatically load and display media content associated with at least one of the user accounts in response to retrieval of data from the network data store being indicative that the at least one of the user accounts is authenticated; and
a query component configured to acquire network signaling information for a default user account from the network data store and transmit a login message over the network to the default user account in response to the data being indicative that none of the user accounts is authenticated, wherein the default user account is a mobile device account maintained by a mobile communication network provider.

21. A system, comprising:
means for receiving a signal indicative of a power-on event from an electronic component of a network-enabled television;
means for referencing a stored log-on status of a user account associated with the network-enabled television and for determining whether the stored log-on status indicates the user account is logged off;
means for establishing a network communication context in response to the user account being logged off;
means for receiving a user input data in response to initiating the network process; and
means for logging on the user account in response to the user input data matching stored verification data associated with the user account.

22. The system of claim 21, further comprising means for accessing a remote data store via the network communication context and retrieving the stored log-on status.

23. The system of claim 22, further comprising employing the means for accessing the remote data store to retrieve contact information for a communication account associated with the user account and to retrieve the stored verification data.

24. The system of claim 23, further comprising means for transmitting a message comprising the stored verification data to the communication account in response to the stored log-on status being logged off.

25. The system of claim 24, wherein the means for receiving the user input data receives a reply to the message from the communication account, wherein the reply comprises the user input data.
